(19) United States
(12) Patent Application Publication
(10) Pub. No.: US 2010/0084784 A1
(43) Pub. Date: Apr. 8, 2010

(54) Fabrication of Biomimetic Scaffolds with Well-Defined Pore Geometry by Fused Deposition Modeling

(75) Inventor: Esmaiel Jabbari, Columbia, SC (US)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 12/575,867

(22) Filed: Oct. 8, 2009

Related U.S. Application Data
(60) Provisional application No. 61/195,628, filed on Oct. 8, 2008.

(51) Int. Cl. B29C 33/38

(52) U.S. Cl. 264/219

(57) ABSTRACT

A method for fabrication of a scaffold by fused deposition modeling is provided. The method includes forming a sacrificial mold with fused deposition modeling, the sacrificial mold comprising a dissolvable material. The method further includes infusing the sacrificial mold with a biodegradable composition and applying a solvent to the biodegradable composition infused sacrificial mold to dissolve the sacrificial mold and leave a scaffold formed from the biodegradable composition.

### CROSS REFERENCE TO RELATED APPLICATION

The present application claims is based on and claims priority to U.S. Provisional Application Ser. No. 61/195,628, filed Oct. 8, 2008, which is incorporated by reference herein in its entirety.

### BACKGROUND

It is well established that the pore size and distribution affect the rate of cell migration and the extent of extracellular matrix formation. The pore size and size distribution is random and pores are not fully interconnected when porogen is used to create porosity. Porogen is defined as solid particles like sodium chloride or crystals of saccharose that are mixed with the polymerizing mixture and then leached out after matrix crosslinking to produce a porous structure. Conventional techniques like fiber-bonding, solvent casting and particulate leaching, membrane lamination, melt molding, thermally induced phase separation, and gas foaming do not allow the fabrication of scaffolds with a completely interconnected pore network with a highly regular and reproducible scaffold morphology. Recently, rapid prototyping (RP) or solid freeform fabrication (SFF) technology has been used in the design and fabrication of tissue engineering scaffolds. These include 3D printing, multi-phase jet solidification, shape deposition manufacturing, powder sintering, and fused deposition modeling (FDM).

In comparison with other techniques, FDM is especially attractive because it does not require the use of organic solvents for printing or injection. The FDM method forms three-dimensional objects from computer generated solid or surface models like in a typical RP process. FDM uses a small temperature controlled extruder to force out a thermoplastic filament material and deposit the semi-molten polymer onto a platform in a layer by layer process. The monofilament is moved by two rollers and acts as a piston to drive the semi-molten extrudate. At the end of each finished layer, the base platform is lowered and the next layer is deposited. The designed object is fabricated as a three-dimensional object based on the precise deposition of thin layers of the extrudate. A disadvantage of the conventional FDM technique is that the deposition path and parameters for every layer depend on the build material used and the fabrication conditions.

Thus, improvements in the FDM technique would be desirable.

### SUMMARY

Objects and advantages of the invention will be set forth in part in the following description, or may be obvious from the description, or may be learned through the practice of the invention.

In accordance with certain embodiments of the present disclosure, a method for fabrication of a scaffold by fused deposition modeling is provided. The method includes forming a sacrificial mold with fused deposition modeling, the sacrificial mold comprising a dissolvable material. The method further includes infusing the sacrificial mold with a biodegradable composition and applying a solvent to the biodegradable composition infused sacrificial mold to dissolve the sacrificial mold and leave a scaffold formed from the biodegradable composition.

In certain aspects of the present disclosure, the dissolvable material can comprise a wax. The biodegradable composition can include an unsaturated macromer, a solvent, a crosslinker, an initiator, a co-initiator, or combination thereof. The solvent can comprise a hydrocarbon solvent that is configured to dissolve the sacrificial mold but not dissolve the scaffold formed from the biodegradable composition.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figures in which:

FIG. 1 illustrates the structure of PLGF macromer used with FDM, in accordance with certain aspects of the present disclosure.

FIG. 2 illustrates a GPC chromatograph of ULMW PLGA & PLGF, in accordance with certain aspects of the present disclosure.

FIG. 3 illustrates the structure and properties of SLGA macromer, in accordance with certain aspects of the present disclosure.

FIG. 4 illustrates a CAD design of the rectangular models with cubic pore geometry, in accordance with certain aspects of the present disclosure.

FIG. 5 illustrates a sacrificial wax mold, in accordance with certain aspects of the present disclosure.

FIG. 6 illustrates fabrication of cell-responsive PLGF scaffolds with completely interconnected pore geometry by FDM, in accordance with certain aspects of the present disclosure.

FIG. 7 illustrates degradation characteristics of the PLGF scaffold, in accordance with certain aspects of the present disclosure.

FIG. 8 illustrates an image of seeded BMs cells on PLGF/Ac-GRGD scaffold fabricated by FDM (40×), in accordance with certain aspects of the present disclosure.

FIG. 9 illustrates an image of seeded cells on a section of the PLGF scaffold fabricated by FDM at higher magnification (200×), in accordance with certain aspects of the present disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

Generally, the present disclosure provides an improved method for fabrication of biodegradable and shape-specific polymeric scaffolds. Such scaffolds can include well-defined pore geometry, functionalized with covalently attached bioactive peptides, for applications in tissue regeneration.

It is well established that the pore size and distribution affect the rate of cell migration and the extent of extracellular matrix formation. The present disclosure describes a process for fabrication of biodegradable and shape-specific polymeric scaffolds with well-defined pore geometry, functionalized with covalently attached bioactive peptides, for applications in tissue regeneration. Fused Deposition Modeling (FDM) rapid prototyping technology to fabricate degradable and functional scaffolds with well-defined pore geometry was used. In certain embodiments, computer aided design (CAD) using SolidWorks was used to create models of the cubic orthogonal geometry. The models were used to create the machine codes necessary to build the scaffolds with FDM with wax as the build material. A novel biodegradable in-situ crosslinkable macromer, poly(lactide-co-glycolide fumarate) or PLGF, mixed with reactive functional peptides was infused in the scaffold and allowed to crosslink. The scaffold was then immersed in a hydrocarbon solvent to remove the wax, leaving just the PLGF behind as the support material dissolved. The pore morphology of the PLGF scaffold was imaged with micro-computed tomography and scanning electron microscopy. Cellular function in the PLFG scaffolds with well-defined pore geometry was studied with bone marrow stromal cells isolated from rats. Results demonstrate that the scaffolds support homogeneous formation of mineralized tissue.

The following examples are meant to illustrate the disclosure described herein and are not intended to limit the scope of this disclosure.

### Examples

To overcome the shortcomings of conventional fused deposition modeling (FDM) techniques, the FDM technique was modified to design and fabricate biodegradable solid scaffolds with defined pore geometry and interconnected networks independent of the build material.

For instance, in certain conventional FDM processes, rectangular porous models 32 mm in length, 25 mm in width and 10 mm in height are created with Pro/Engineer and exported into Insight software in .stl format. The Insight software translates the Pro/Engineer STL spatial geometry information into two-dimensional machine language that the FDM-3000 uses to build the scaffold layer-by-layer using hot extruded build material and support material laid down in 250 to 400 um width struts. When the object is immersed in an ultra-sonic water bath the support material dissolves, leaving just the build material portion of the object behind. The process was modified such that the water soluble support material is used as build material to construct the scaffold. The biodegradable polymeric macromer is infused in the scaffold and allowed to crosslink. The scaffold is then immersed in an ultrasonic water bath, leaving just the nanocomposite scaffold behind as the support material dissolves.

### Methods

Synthesis and characterization of ULMW PLGA: The rate of in situ hardening of poly(lactide-co-glycolide fumarate (PLGF) depends on the density of unsaturated fumarate groups in the macromer. High density of unsaturated groups in the macromer can be obtained by using ultra low molecular weight poly(lactic-co-glycolic acid) (ULMW PLGA). ULMW PLGA was synthesized by ring opening polymerization of the lactide (L) and glycolide (G) monomers in a dry atmosphere with diethylene glycol (DEG) as the bifunctional initiator as described in Jabbari E, He X. 2006. “Synthesis and Characterization of Bioresorbable in situ Crosslinkable Ultra Low Molecular Weight Poly(lactide) Macromer”, J. Mater. Sci. Mater. Med., in Press and 23. Jabbari E, He X. 2006. “Synthesis and material properties of functionalized lactide oligomers as in situ crosslinkable scaffolds for tissue regeneration”, Polym. Prepr. 47-2:353-354, both incorporated by reference herein. The molar ratio of DEG to TOC was 25:1. The molar ratio of L and G to DEG was varied from 10 to 30 to produce ULMW PLGA with Mn in the range of 1-4 kDa. The ampoules were sealed under nitrogen atmosphere at 140° C. and the reaction was continued for 12 h at the same temperature. The resulting polymer mixture was dissolved in methylene chloride (MC), precipitated in methanol to remove the high molecular weight fraction. Next, the methanol was removed by rotovaporation, the polymer was re-dissolved in MC and precipitated twice in hexane. The precipitate was dried in a vacuum of <5 mmHg at 40° C. for at least 12 h and stored in a dry atmosphere. The synthesized polymer was characterized by ¹H-NMR and GPC. In the NMR spectrum of ULMW PLGA, a doublet chemical shift with peak position at 1.6 ppm (methyl hydrogens of the lactide), two triplets with peaks positions at 3.6 and 4.2 ppm (methylene hydrogels of DEG), and a quartet (lactide methine hydrogen) or doublet (glycolide methyl hydrogens) with peak location at 5.1 ppm were observed. For ULMW PGA, the doublet chemical shift at 1.6 ppm was absent (no methyl group in glycolide) and the quartet shift at 5.1 ppm was replaced with a double intensity singlet. The Mn of the ULMW PLGA ranged from 1-2 kDa with polydispersity index of 1.1-1.3, respectively (see FIG. 2).

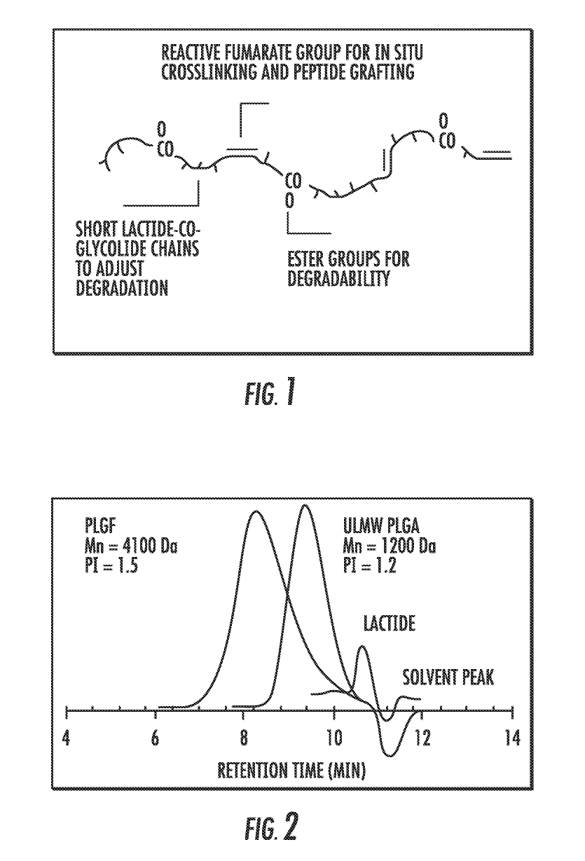

Synthesis and characterization of PLGF: The structure of the PLGF macromer is shown in FIG. 1. PLGF was synthesized by condensation polymerization of ULMW PLGA with fumaryl chloride (FuCl) as described previously. The molar ratio of FuCl:PLGA and TEA:PLGA was 0.9:1.0 and 1.8:1.0, respectively. The Mn of ULMW PLGA ranged from 1-2 kDa with polydispersity index of 1.1-1.3, respectively.

In a typical reaction, 20 g of ULMW PLGA was dissolved in 150 ml of MC under dry nitrogen atmosphere in a reaction flask. Next, 0.61 ml of FuCl and 1.55 ml of TEA, each dissolved in MC, were added dropwise to the reaction with stirring. The reaction was continued for 6 h under ambient conditions. After completion of the reaction, solvent was removed by rotovaporation and residue was dissolved in anhydrous ethyl acetate to precipitate the by-product triethylamine hydrochloride and the salt was removed by filtration. Ethyl acetate was removed by vacuum distillation. The macromer was re-dissolved in MC and precipitated twice in ethyl ether. The product was dried in vacuum (<5 mmHg) at ambient temperature for at least 12 h and stored at −20° C. The structure of PLGF macromer was characterized by ¹H-NMR, ¹³C-NMR, and FTIR.

The presence of chemical shifts centered at 6.90 ppm and 134 ppm in ¹H-NMR and ¹³C-NMR spectra attributable to hydrogens and carbons of the fumarate, and the presence of a band due to carbonyl stretching vibration centered at 1725 cm⁻¹ in the FTIR spectrum, confirmed the incorporation of fumarate into PLGF macromer. The GPC chromatogram of PLGF with L:G ratio of 1 is shown in FIG. 2. ULMW PLGA with Mn of 1.2 kDa produced PLGF with Mn of 4.1 kDa.

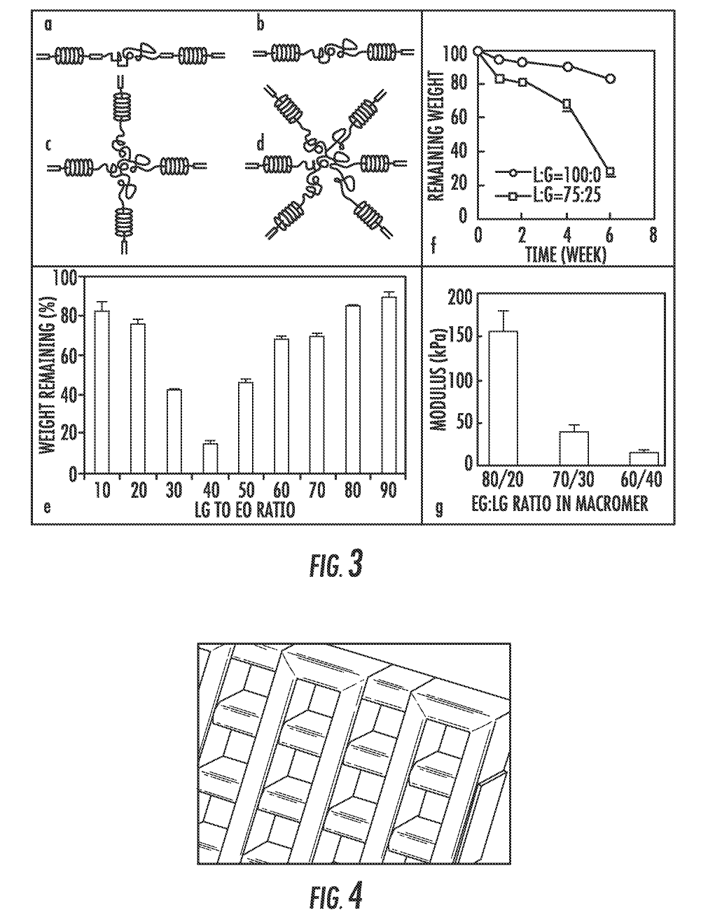

Synthesis of star lactide-glycolide-acrylate (SLGA) macromer: SLGA macromers have been developed can be crosslinked with redox or photoinitiators to produce degradable hydrogels. Schematic diagram of the sELGA macromer is shown in FIG. 3. The macromer consists of a multi-arm (3, 4, 6, or 8) ethylene oxide (EO) core with very short lactide-glycolide (LG) chains terminated with an acylate group attached to each arm, as shown in FIG. 3. In FIG. 3, schematics a-d show the 3, 4, 6, and 8 arms SLGA macromers, respectively. The ethylene oxide core (shown in blue in FIG. 3) provides hydrophilicity and controlled water uptake to improve viability of seeded cells. The short LG chains (shown in green in FIG. 3) provide degradability and hydrophophobicity to control water uptake while the unsaturated acrylate groups provide functional groups for crosslinking The rate of crosslinking is controlled by the number of arms on each macromer. Experimental results demonstrate that when M̅ₙ̅ of the LG segments is >3 kDa, due to the low density of unsaturated groups, the polymerizing macromer does not reach gelation point. The crosslink density can be controlled by the number or arms in each macromer and the macromer molecular weight. The water uptake (hence viability of seeded cells) is controlled by EO:LG ratio and the hydrogel crosslink density. The modulus of the crosslinked macromer depends on EO:LG ratio, number of arms in each macromer, and macromer molecular weight. The degradation characteristics depend on lactide to glycolide ratio in the LG units and EO:LG ratio. For example, FIG. 3e shows that hydrogels with high LG content (higher hydrophobicity) and high EO content (lower degradability) have slow degradation (after 3 weeks) while EO:LG ratios between 30% to 50% have faster degradation rate. FIG. 3f shows that degradation, measured by weight loss after 6 weeks, can be increased from <10% to >70% by changing the lactide to glycolide ratio from 100:0 to 75:25, at constant EO:LG ratio. FIG. 3g shows that the modulus of the hydrogel is increased by one order of magnitude as the EG:LG ratio is changed from 60/40 to 80/20.

As illustrated in FIG. 3a-d, the macromer comprises lactide and glycolide blocks, ethylene oxide blocks, and unsaturated fumarate or acrylate units. The distinguishing feature of this macromer is the short PLGA chains allowing the macromer to crosslink, through the unsaturated groups, to form a hydrogel. (a) and (b) are linear SLGA with multiple or two unsaturated groups while (c) and (d) are 4-arm and 6-arm SLGA; graphs (e) and g show that degradation and modulus of the hydrogel depend on LG:EO ratio; graph (f) shows that hydrogel degradation also depends on Lactide to glycolide ratio.

Synthesis of Acrylated RGDG peptide: To covalently attach the integrin-binding RGD peptide to the PLGF network for fabrication of functional cell-responsive scaffolds, an unsaturated acrylate group was linked to the peptide at the arginine end using a glycine linker (RGDG-Ac). The Rink Amide NovaGel resin, all Fmoc-protected amino acids, and hydroxybenzotriazole (HOBt) were purchased from Novabiochem (EMD Biosciences, San Diego, Calif.). The RGDG sequence was synthesized manually on the resin (0.62 mmol/g) as described in He X, Jabbari E. 2006. “Solid-phase synthesis of reactive peptide crosslinker by selective deprotection”, Prot. Peptide Lett. 13:715-718, incorporated by reference herein. 100 mg of the resin was swelled in N,N-dimethylformamide (DMF; Acros Organics, Pittsburg, Pa.) for 30 min and then drained. The Fmoc-protected arginine derivative (1 eq) and HOBt (2 eq) were dissolved in DMF (3 mL), N,N′-diisopropylcarbodiimide (DIC; 1.1 eq; Acros) was added to the mixture, agitated for 5-10 min, and added to the resin. Next, 0.2 ml of 0.05 M N,N-dimethylaminopyridine (DMAP; Acros) was added, and the mixture was shaken for 4-6 hr at 30° C. in an orbital shaker. A small amount of the resin was removed and tested for the presence of unreacted amines using the Kaiser reagent. If the test result was positive, the resin was washed with DMF (5×3 mL) and the coupling reaction was repeated. If the test result was negative, the resin was washed with DMF (5×3 mL), treated with 20% piperidine (Sigma-Aldrich) in DMF for 2×15 min, and washed with DMF. The subsequent Fmoc-protected glycine, aspartic acid, and glycine amino acids were coupled using the same method. After coupling the last amino acid, the resin was washed with 5×DMF and 5×DCM. The -Fmoc protecting group of the amino acid residues was selectively deprotected with 20% piperidine in DMF for 2×15 min. The resin was washed with DMF (5×3 ml) after deprotection.

The RGDG peptide was functionalized with an acrylate end-group directly on the peptidyl resin by coupling acrylic acid to the amine group of the glycine residue. Acrylic acid (12 eq) and HOBt (24 eq) were dissolved in DMF (3 mL), and DIC (13.2 eq) was added to the mixture. The resulting mixture was shaken 5-10 min, added to the resin, and shaken for 4-6 hr at 30° C. on an orbital shaker. The above coupling reaction was repeated once more. If the Kaiser test was negative, the resin was washed with DMF (5×3 mL) and DCM (3×3 mL), otherwise the coupling reaction was repeated. Next, the resin was treated with 95% trifluoroacetic acid (TFA; Acros)/2.5% triisopropylsilane (TIPS; Acros)/2.5% water for 2 hr to cleave the peptide crosslinker from the resin. The mixture was poured into cold ether and kept at −20° C. for 24 h to precipitate the product. The suspension was centrifuged, the supernatant was decanted, and the solid was freeze-dried. The product was further purified by preparative HPLC. The HPLC fraction was lyophilized using a freeze-dryer. The product was characterized with a Fannigan 4500 Electro Spray Ionization (ESI) spectrometer. The peak in the ESI-MS spectrum at 457 m.n. corresponded to the hydrogen cation of the Ac-GRGD peptide.

Scaffold fabrication: Rectangular porous models 32 mm in length, 25 mm in width and 10 mm in height were created with Pro/Engineer and exported into Insight software in .stl format as described in Jabbari E, Lee K W, Ellison A C, Moore M J, Tesk J A, Yaszemski M J. 2004. “Fabrication of Shape Specific Biodegradable Porous Polymeric Scaffolds with Controlled Interconnectivity by Solid Free-Form Microprinting”, Trans. Soc. Biomaterials. p. 1348, incorporated by reference herein. Each model was cut into 50 horizontal layers with a slice thickness of 250 μm. For all the layers, a single contour and raster-fill pattern of 0/90° and a fill gap of 600 μm were used to form the honeycomb square patterns shown in FIG. 4.

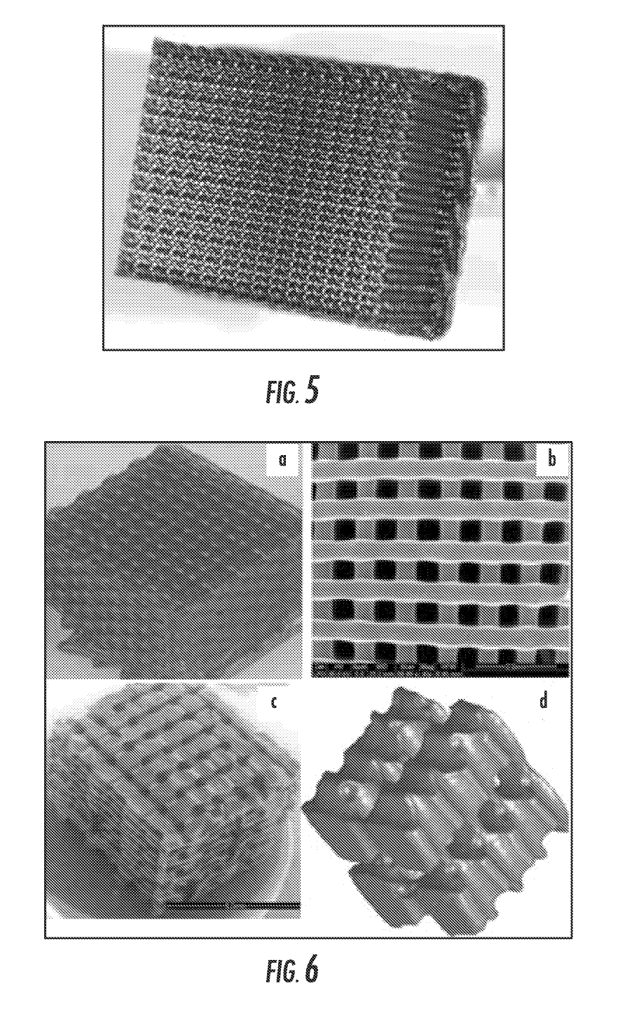

An FDM-3000 RPS system was used to build the porous sacrificial mold layer-by-layer using hot extruded water soluble support material laid down in 400 μm width struts. An illustration of the extruded sacrificial mold for the scaffold is shown in FIG. 5. The finished mold was infused with the biodegradable polymerizing mixture and allowed to crosslink in a conduction oven at 40° C. for 30 min.

PLGF macromer was mixed with different amounts of NVP crosslinker ranging from 5 to 20% by weight. Hydroxyapatite (HA) osteoconductive particles, 5-20% based on the weight of PLGF, was added to improve compressive strength of the scaffolds. 50 μl benzoyl peroxide (BPO) solution (50 mg BPO in 250 μl of NVP) as the initiator and 40 μl dimethyl toluidine (DMT) solution (20 μl DMT in 1 ml NVP) as the accelerator were added to the mixture. Rectangular porous models 32 mm in length, 25 mm in width and 10 mm in height will be created with Pro/Engineer and exported into Insight software in .stl format as described above. The sacrificial mold was infused with the PLGF polymerizing mixture and allowed to crosslink at 37° C. for 30 min. The mold was immersed in hexane (a hydrocarbon solvent that dissolved the wax but did not swell the crosslinked PLGF) for 24 h to remove the wax, leaving just the PLGF scaffold behind. The pore morphology was studied by SEM as described in Jabbari E, Peppas N A. 1995. “Quantitative Measurement of Interdiffusion at Polymer-Polymer Interfaces with TEM/EDS and EELS”, J. Appl. Polym. Sci. 57:775-779, incorporated by reference herein, and micro-computed tomography.

The pore morphology of the scaffolds was studied with an environmental scanning electron microscope (ESEM) FEI XL30 equipped with an electron backscattered detector. The scaffold was attached to the SEM stub with a double-sided tape and imaged at an accelerating voltage of 30 kV. The porous scaffolds were also imaged with a micro-digital radiography scanner, assembled at Savannah River National Laboratories (Micro-DR 2006-001; SRNL, Aiken, S.C.). The scanner consisted of a 160-kVp micro-focus X-ray machine (Kevex 16010, Thermo Fisher Scientific, Waltham, Mass.), a four-axis positioning system (series 300, New England Affiliated Technologies, Lawrence, Mass.), and an amorphous silicon flat panel imager (Paxscan 4030, Varian, Palo Alto, Calif.). The sample was mounted on a rotational stage and rotated incrementally in 0.5° steps to produce 15 μm digital radiographic images. The image acquisition process was controlled by LabView software (National Instruments, Austin, Tex.). The classical Feldkamp reconstruction algorithm was used to reconstruct the two-dimensional digital radiograms into a three-dimensional volumetric data-set.

PLGF scaffold degradation: Degradation was measured as a function of time in vitro in primary culture media (CM; 5 ml per sample) without fetal bovine serum (FBS) at 37° C. under mild agitation. To prepare the primary media without FBS, 13.4 g of DMEM was dissolved in 900 ml of distilled deionized water (DDI) water containing 3.7 g sodium bicarbonate (SB), and 10 ml antibiotic and antimycotic agents (1% v/v). The antibiotic and antimycotic agents included 50 μg/ml GS, 100 μg/ml streptomycin (Sigma), and 250 ng/ml fungizone. At each time point, samples were removed from the media, washed with DDI water to remove excess electrolytes, and dried in vacuum. The dry sample weight was recorded and compared with the initial dry weight to determine fractional mass remaining.

Bone marrow stromal cell isolation: BMS cells were obtained from the bone marrow of young adult male Wistar rats as described in He X, Jabbari E. 2007. “Material Properties and Cytocompatibility of Injectable MMP Degradable Poly(lactide ethylene oxide fumarate) Hydrogel as a Carrier for Marrow Stromal Cells”, Biomacromolecules, 8:780-792, incorporated by reference herein. After euthanasia, the femurs and tibias were aseptically excised from the hind limbs and washed in DMEM containing gentamicin sulfate (100 μg/ml). Plugs of marrow were extracted by cutting the distal ends of tibias and proximal ends of femurs to expose the marrow cavity. The marrow was flushed out with 5 ml of primary culture media (DMEM supplemented with 10% FBS; Atlantic Biologicals), 20 μg/ml fungizone, and 20 μg/ml GS. Cell clumps were broken up by repeatedly pipetting and the cell suspensions were combined and centrifuged at 200×g for 5 min. The resulting supernatant was aspirated and cell pellets re-suspended in 12 ml primary media and aliquoted into T-75 flasks (cells from one rat per flask). The flasks were subsequently maintained in a humidified 5% CO2 incubator at 37° C. Cultures were washed with PBS and replaced with fresh media at 3 and 7 days to remove haematopoetic cells and other unattached cells from the flasks. After 10 days, sub-confluent monolayer cells (yielding approximately 3×10⁶ cells per flask) were lifted enzymatically and centrifuged. To assess the potential of BMS cells for osteogenic differentiation, cells were lifted enzymatically, centrifuged in 2 ml conical tubes, and allowed to form compact cell pellets in osteogenic media (primary media supplemented with 50 μg/ml L-ascorbic acid, 10 nM dexamethasone, and 10 mM Na β-glycerol phosphate). After 4 weeks, pellets were fixed, embedded, sectioned and stained with haematoxylin and eosin for cell evaluation and with von Kossa's silver nitrate for mineralized tissue. The 2nd passage cells were used for cell culture experiments.

Cell seeding and attachment: Scaffolds were sterilized and seeded with undifferentiated 2nd passage BMS cells. The bottom of 24 well plates was coated with 300 μl of 2% agarose solution to make the wells non-adherent to BMS cells as described in Jabbari E, Hefferan T E, Lu L, Pedersen L G, Currier B L, Yaszemski M J. 2004. “In vitro migration and proliferation of human osteoblasts in injectable in situ crosslinkable poly(caprolactone fumarate) scaffolds”, In: Advances in biomaterials, bionanotechnology, biomimetic systems and tissue engineering, Peppas N A, Anseth K, Dillow A K, Schmidt C E, Eds., AIChE, New York, pp. 55-57, incorporated by reference herein. A scaffold was placed in each well and seeded with 250 μl of BMS cell suspension in primary media at a density of 2×10⁶ cells/cm². Subsequently, plates will be incubated for 48 h for cell attachment. Next, the scaffolds were stained with fluorescent dyes calcein AM and ethidium homodimer-1 (Molecular Probes, Eugene, Oreg.) for visualization of live and dead cells. A confocal fluorescent microscope (Zeiss LSM-510 META Axiovert, Carl Zeiss; USC School of Medicine) was utilized to obtain depth projection micrographs.

### Results and Discussion

It is well established that the pore size and distribution affects the rate of cell migration and the extent of extracellular matrix formation. In comparison with other techniques, Fused Deposition Modeling (FDM) is especially attractive because it does not require the use of organic solvents for printing/injection. Rectangular porous models 32 mm in length, 25 mm in width and 10 mm in height were created with Pro/Engineer and exported into Insight software in .stl format. Each model was cut into 50 horizontal layers with a slice thickness of 250 μm. For all the layers, a single contour and raster-fill pattern of 0/90° and a fill gap of 600 μm were used to form the honeycomb pattern of squares, as shown in FIG. 4. An FDM-3000 RPS system was used to build the porous sacrificial mold layer-by-layer using hot extruded wax laid down in 400 μm width struts, as shown in FIG. 6a (3-D image) and 6b (2-D cross sectional image). The finished mold was infused with the PLGF/Ac-GRGD polymerizing mixture and allowed to crosslink at 37° C. for 30 min. The viscous polymerizing mixture consisted of PLGF macromer, N-vinyl pyrrolidinone (NVP) crosslinker, Ac-GRGD multi-functional peptide, HA nanoparticles, benzoyl peroxide initiator, and dimethyl toluidine accelerator. The construct was immersed in hexane for 12 h to remove the wax, leaving just the scaffold behind as the support material dissolved. FIG. 6c shows the ESEM image of the cubic scaffold (8×8×5 mm). FIG. 6d shows the 3-D reconstruction of a portion of the scaffold from the 2-D 15 μm micro-CT images, respectively. The last two images show the completely interconnected pore morphology of the scaffold.

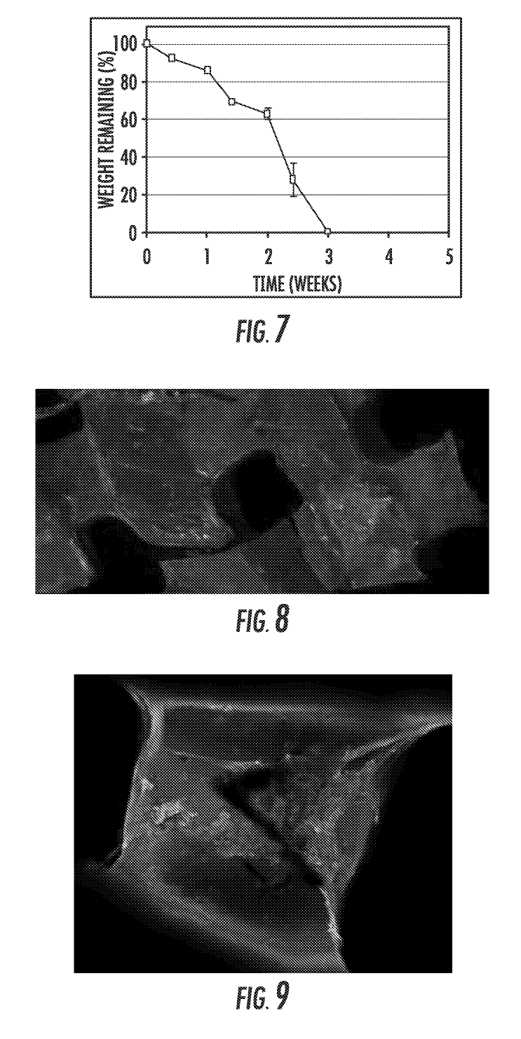

The degradation curve of PLGF (50:50 LA:GL) in primary culture media (without FBS) at 37° C. is shown in FIG. 7. According to this figure, the degradation rate was approximately zero-order with respect to incubation time; that is the crosslinked PLGF networks degraded by surface degradation mechanism. It is well-established that PLGA polymers degrade by bulk hydrolysis in which there is no mass loss until a critical molecular weight has reached after which the sample mass is lost by erosion as described in Mohammadi Y, Jabbari E. 2006. “Monte carlo simulation of degradation of porous poly(lactide) scaffolds: I. Effect of porosity on pH”, Macromol. Theory Simul. 15:643-653, incorporated by reference herein. FIG. 7 demonstrates that the degradation mechanism of the crosslinked PLGF, synthesized from ULMW PLGA, differs from that of the higher molecular weight uncrosslinked PLGA polymers.

The image of the seeded cells in the PLGF/Ac-GRGD scaffolds is shown in the confocal laser scanning micrograph of FIG. 8. The image illustrates the background fluorescence of PLGF scaffold as well as the fluorescent images of the BMS cells cytoskeleton. This image clearly demonstrates that the BMS cells are homogeneously distributed on the PLGF scaffold grafted with the Ac-GRGD cell-adhesive peptide. FIG. 9 shows the cell morphology of the seeded cells at a higher magnification. The mechanical properties (compressive and tensile strength) of the scaffolds can also be determined.

### CONCLUSION

Results demonstrate that biodegradable PLGF scaffolds with well-defined pore-geometry and complete pore interconnectivity, grafted with cell-responsive groups, can be fabricated by fused deposition modeling. The PLGF scaffolds with complete interconnectivity are attractive as biodegradable scaffolds for skeletal tissue regeneration.

In the interest of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so as further described in such appended claims.

What is claimed:

1. A method for fabrication of a scaffold by fused deposition modeling comprising:
forming a sacrificial mold with fused deposition modeling, the sacrificial mold comprising a dissolvable material;
infusing the sacrificial mold with a biodegradable composition;
applying a solvent to the biodegradable composition infused sacrificial mold to dissolve the sacrificial mold and leave a scaffold formed from the biodegradable composition.

2. A method as in claim 1, wherein the dissolvable material comprises wax.

3. A method as in claim 1, wherein the biodegradable composition comprises an unsaturated macromer.

4. A method as in claim 3, wherein the unsaturated macromer comprises poly(lactide-co-glycolide fumarate).

5. A method as in claim 1, wherein the biodegradable composition comprises a solvent.

6. A method as in claim 5, wherein the solvent in the biodegradable composition comprises methylene chloride, dimethyl fomamide, or combinations thereof.

7. A method as in claim 1, wherein the biodegradable composition comprises a crosslinker.

8. A method as in claim 7, wherein the crosslinker comprises n-vinyl methyl pyrrolidinone.

9. A method as in claim 1, wherein the biodegradable composition comprises an initiator comprising benzoyl peroxide.

10. A method as in claim 9, wherein the biodegradable composition comprises a co-initiator comprising dimethyltoluidine.

11. A method for fabrication of a scaffold by fused deposition modeling comprising:
forming a sacrificial mold with fused deposition modeling, the sacrificial mold comprising a dissolvable material;
infusing the sacrificial mold with a biodegradable composition comprising poly(lactide-co-glycolide fumarate);
applying a solvent to the biodegradable composition infused sacrificial mold to dissolve the sacrificial mold and leave a scaffold formed from the biodegradable composition.

12. A method as in claim 11, wherein the dissolvable material comprises wax.

13. A method as in claim 11, wherein the biodegradable composition further comprises a solvent.

14. A method as in claim 13, wherein the solvent comprises methylene chloride, dimethyl fomamide, or combinations thereof.

15. A method as in claim 11, wherein the biodegradable composition further comprises a crosslinker.

16. A method as in claim 15, wherein the crosslinker comprises n-vinyl methyl pyrrolidinone.

17. A method as in claim 11, wherein the biodegradable composition further comprises an initiator comprising benzoyl peroxide.

18. A method as in claim 17, wherein the biodegradable composition further comprises a co-initiator comprising dimethyltoluidine.

19. A method for fabrication of a scaffold by fused deposition modeling comprising:
forming a sacrificial mold with fused deposition modeling, the sacrificial mold comprising wax;
infusing the sacrificial mold with a biodegradable composition comprising poly(lactide-co-glycolide fumarate);
applying a solvent to the biodegradable composition infused sacrificial mold to dissolve the sacrificial mold and leave a scaffold formed from the biodegradable composition, wherein the solvent comprises a hydrocarbon solvent that is configured to dissolve the sacrificial mold but not dissolve the scaffold formed from the biodegradable composition.

20. A method as in claim 19, wherein the biodegradable composition further comprises a solvent, a crosslinker, an initiator, and a co-initiator.
